(19) United States
(12) Patent Application Publication
(10) Pub. No.: US 2026/0044551 A1
(43) Pub. Date: Feb. 12, 2026

(54) METHOD AND SYSTEM FOR GENERATING A PERSONALIZED SUMMARY OF CONTENT

(71) Applicant: ProphetStor Data Services, Inc., Taichung (TW)

(72) Inventors: Wen-Shyen Chen, Taichung City (TW); Jonathan Chen, Milpitas, CA (US)

(21) Appl. No.: 18/799,379

(22) Filed: Aug. 9, 2024

(51) Int. Cl. G06F 16/34; G06F 16/9035; G06F 16/906

(52) U.S. Cl. CPC G06F 16/345; G06F 16/9035; G06F 16/906

(57) ABSTRACT

The present invention provides a method for generating a personalized summary of content and a system thereof. The method includes the steps of: storing a user profile of a user and/or a user-annotated content; retrieving multimodal contents from various online sources based on the user profile; storing the user-annotated content obtained from the user subsystem, and the multimodal contents obtained from the data retrieval module; selecting pertinent material from the multimodal contents and/or the user-annotated content; and autonomously generating a personalized content summary based on the selected pertinent material by a generative artificial intelligence (AI) module.

### FIELD OF THE INVENTION

The present invention relates to a method and a system for generating a personalized summary of content. More particularly, the present invention relates to a method and a system for generating a personalized summary of content through a natural language interaction application.

### BACKGROUND OF THE INVENTION

Various technologies and methods exist for content summarization and generation. Traditional rule-based systems rely on algorithms that identify critical sentences based on specific criteria like keyword frequency and sentence position. More advanced approaches involve machine learning algorithms such as Support Vector Machines and Random Forests to classify and rank sentences for summarization. Natural Language Processing techniques, including Named Entity Recognition, Coreference Resolution, and Sentiment Analysis, contribute to understanding the context and semantics of text. Generative AI models like GPT-4 and BERT have emerged as powerful tools, capable of generating human-like, contextually relevant, and semantically rich text. These models can be fine-tuned for various tasks, including summarization, content creation, and personalized recommendations, and some offer multi-modal capabilities by integrating text, images, and audio. Collaborative filtering, common in recommendation systems, suggests content based on user behavior, while multi-modal systems combine text, images, and audio for content generation. Personalization engines use user profiles and behavior to tailor content, often in the form of summaries or recommendations.

However, existing technologies face several limitations. Firstly, they often lack context awareness, focusing narrowly on individual behavior without considering broader social and relational contexts. Secondly, there is an over-reliance on algorithms, which, while efficient at analyzing and summarizing content, lack the nuanced understanding provided by human insight and collaborative intelligence. Thirdly, many systems are limited to single modalities, such as text, and struggle to effectively integrate multiple data types. Fourthly, concerns about data privacy arise as personalization often requires extensive data collection. Additionally, the quality of summaries generated by rule-based and some machine learning approaches can lack insight, missing nuances or emphasizing less critical points. Scalability becomes an issue as data volume increases, making it challenging for existing technologies to provide real-time, high-quality summaries. Moreover, static personalization systems fail to adapt to changing user needs or social dynamics. Collaboration is limited, with existing systems underutilizing the wisdom of trusted social circles in content summarization. Finally, most systems lack a mechanism for adaptive feedback, leading to stagnant performance over time.

Hence, there is a desperate need for a system and method that leverage advanced Generative AI models in the initial phase of content summarization and generation. This system should employ machine learning algorithms for real-time analytics and adaptive responses to user preferences and social contexts, as well as integrate human-generated annotations, highlights, and other input forms to enrich the summarization process. It would be highly beneficial if the system could also employ algorithms capable of understanding both individual user preferences and broader social contexts to enhance the relevance and personalization of generated summaries. Furthermore, it should be designed to be modular and scalable, accommodating the seamless integration of various media types, including but not limited to text, audio, and video.

By confronting the aforementioned limitations, the present invention aspires to revolutionize the domain of content summarization and generation. It distinctively integrates context-aware, collaborative intelligence with advanced Generative AI. The system further integrates an adaptive feedback mechanism, enabling continuous enhancement of its performance and ensuring ongoing optimization of the personalization and depth of the content.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims. The following presents a simplified summary of one or more aspects of the present disclosure to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

The present invention represents a state-of-the-art, context-aware system designed to reshape the realm of content summarization and generation. It seamlessly integrates Generative AI with collaborative intelligence, employing an Intelligent Selection Process to craft exceptionally personalized, insightful, and contextually relevant summaries or other content forms. The modular system comprises interlinked components that work synergistically to accomplish its objectives.

In one aspect, the present invention provides a method for generating a personalized summary of content which includes the steps of: storing a user profile of a user and/or a user-annotated content; retrieving multimodal contents from various online sources based on the user profile; storing the user-annotated content obtained from the user subsystem, and the multimodal contents obtained from the data retrieval module; selecting pertinent material from the multimodal contents and/or the user-annotated content; and autonomously generating a personalized content summary based on the selected pertinent material by a generative artificial intelligence (AI) module.

Preferably, the user profile comprises social context, preferences, objectives, formats, sentiment, behavior, and trusted online sources predetermined by the user, and the personalized content summary is adjusted accordingly.

Preferably, each of the multimodal contents is assigned a trust score determined by a trustworthiness of an individual and/or community who supplied the multimodal contents.

Preferably, the pertinent material is selected from the multimodal contents according to a ranking of the trust scores assigned to each multimodal content.

Preferably, the trust score is dynamically adjusted based on a feedback of the user, and forwarded to the generative AI module for fine-tuning.

Preferably, the user evaluates the quality and relevance of the personalized content summary by assigning a quality validation score, which is derived from both an anticipated value and an actual delivered value.

Preferably, the personalized content summary is regenerated by the generative AI module through a reselection of pertinent material if the quality validation score falls below a predetermined threshold.

Preferably, the multimodal contents and the personalized content summary comprises text, images, audio, video, and interactive elements.

Preferably, at least one of the user-annotated content and the multimodal contents comprises comments, highlights, and notes.

Preferably, the personalized content summary is generated by Natural Language Processing (NLP) and Machine Learning (ML) algorithms.

In another aspect, the present invention provides a system for generating a personalized summary of content which includes: a user subsystem, for storing a user profile of a user and/or a user-annotated content; a data retrieval module, connected to the user subsystem, for retrieving multimodal contents from various online sources based on the user profile; a content database, connected to the user subsystem and the data retrieval module, for storing the user-annotated content obtained from the user subsystem, and the multimodal contents obtained from the data retrieval module; a selection module, connected to the content database, for selecting pertinent material from the multimodal contents and/or the user-annotated content; and a generative artificial intelligence (AI) module, connected to the selection module, for autonomously generating a personalized content summary based on the selected pertinent material.

Preferably, the user profile comprises social context, preferences, objectives, formats, sentiment, behavior, and trusted online sources predetermined by the user, and the personalized content summary is adjusted accordingly.

Preferably, each of the multimodal contents is assigned a trust score determined by a trustworthiness of an individual and/or community who supplied the multimodal contents.

Preferably, the pertinent material is selected from the multimodal contents according to a ranking of the trust scores assigned to each multimodal content.

Preferably, the trust score is dynamically adjusted based on a feedback of the user, and forwarded to the generative AI module for fine-tuning.

Preferably, the user evaluates the quality and relevance of the personalized content summary by assigning a quality validation score, which is derived from both an anticipated value and an actual delivered value.

Preferably, the quality validation score is feedback to the selection module if the quality validation score falls below a predetermined threshold, and the personalized content summary is regenerated by the generative AI module through a reselection of pertinent material.

Preferably, the multimodal contents and the personalized content summary comprises text, images, audio, video, and interactive elements.

Preferably, at least one of the user-annotated content and the multimodal contents comprises comments, highlights, and notes.

Preferably, the personalized content summary is generated by Natural Language Processing (NLP) and Machine Learning (ML) algorithms.

### BRIEF DESCRIPTION OF THE DRAWINGS

FIG. 1 is a block diagram illustrating major components of a system for generating a personalized summary of content according to an embodiment of the present invention.

FIG. 2 is a flowchart illustrating a method for generating a personalized summary of content according to an embodiment of the present invention.

FIG. 3 is a conceptual overview of the method according to an embodiment of the present invention.

FIG. 4 is another conceptual overview of the method according to an embodiment of the present invention.

### DETAILED DESCRIPTION OF THE PREFERRED EMBODIMENTS

The present invention will now be described more specifically with reference to the following embodiments. The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form to avoid obscuring such concepts.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation.

The present invention provides a system and a method for generating a personalized summary of content by use of a natural language interaction application/generative AI application that is based on Natural Language Processing (NLP) and Machine Learning (ML) technologies to deliver a personalized, immersive, and conversational AI-driven educational experience. Natural language interaction application/generative AI application is a software application that uses natural language to interact with a user. It performs functions similar to those provided by human assistants, in that they can engage in conversations with their users in order to for example provide information, carry out routine tasks, or perform other operations as required. Examples of applications featuring natural language interaction and generative AI include Apple's Siri, Amazon's Alexa, Google's BERT, and OpenAI's ChatGPT. It's important to note that the present invention extends beyond these instances and is not limited to the mentioned technologies.

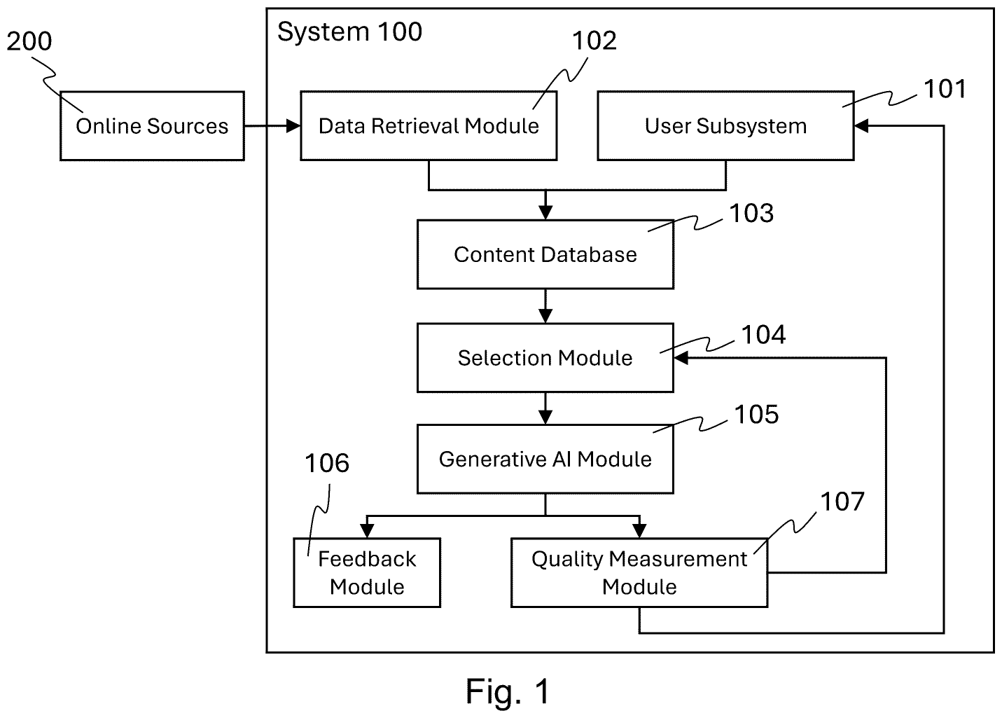

FIG. 1 is a block diagram illustrating major components of a system 100 for generating a personalized summary of content according to an embodiment of the present invention. The system 100 incorporates various interconnected modules to seamlessly tailor content summaries based on individual user profiles and preferences. As shown, the system 100 includes: a user subsystem 101, a data retrieval module 102, a content database 103, a selection module 104, and a generative artificial intelligence (AI) module 105. The system 100 may further include a feedback module 106 and a quality measurement module 107. Descriptions for each element will be provided in the subsequent paragraphs.

The system 100 comprises a user subsystem 101, which functions as a repository for both user profiles and user-annotated content. The data retrieval module 102 interfaces with the user subsystem 101 to retrieve multimodal contents from diverse online sources 200, guided by the distinctive profile of the user. It's important to note that multimodal contents encompass various formats, including text, images, audio, video, and interactive elements.

The content database 103 serves as the storage hub for user-annotated content obtained from the user subsystem 101 and multimodal contents acquired from the data retrieval module 102. The selection module 104 then selects pertinent material aligning with the user's preferences and objectives from the multimodal contents and/or the user-annotated content. The generative AI module 105 takes a prominent role in autonomously constructing personalized content summaries based on the selected pertinent material. The distinguishing feature of this system lies in its capability to consider an extensive array of user-specific parameters included in the user profile, such as social context, preferences, objectives, formats, sentiment, behavior, and trusted online sources.

Notably, the trustworthiness of the multimodal content is quantified through a trust score, considering both individual and community reliability. The selection of pertinent material from the multimodal contents is intricately tied to these trust scores (i.e., according to a ranking of the trust scores assigned to each multimodal content), ensuring that the user receives information from the most credible sources. A feedback loop is established through the feedback module 106, enabling users to provide input on the generated content summaries. This feedback dynamically adjusts the trust scores, fine-tuning the generative AI module 105 for continuous improvement.

User evaluation plays a crucial role, facilitated by a quality validation score derived from both an anticipated value and an actual delivered value. The quality validation score is calculated by the quality measurement module 107, and if the quality validation score falls below a predetermined threshold, the system 100 triggers a regeneration of the personalized content summary. Specifically speaking, the quality validation score will be feedback to the selection module 104 by the quality measurement module 107, and the personalized content summary would be regenerated by the generative AI module 105 through a reselection of pertinent material. Additionally, the incorporation of Natural Language Processing (NLP) and Machine Learning (ML) algorithms ensures the content summaries are not only personalized but also intelligently crafted, reflecting the cutting-edge capabilities of this inventive system.

To more accurately encapsulate the essence of the content intended for summarization, as per the current embodiment, it is recommended that either the user-annotated content or the multimodal contents incorporate comments, highlights, and notes during the process of selecting pertinent material.

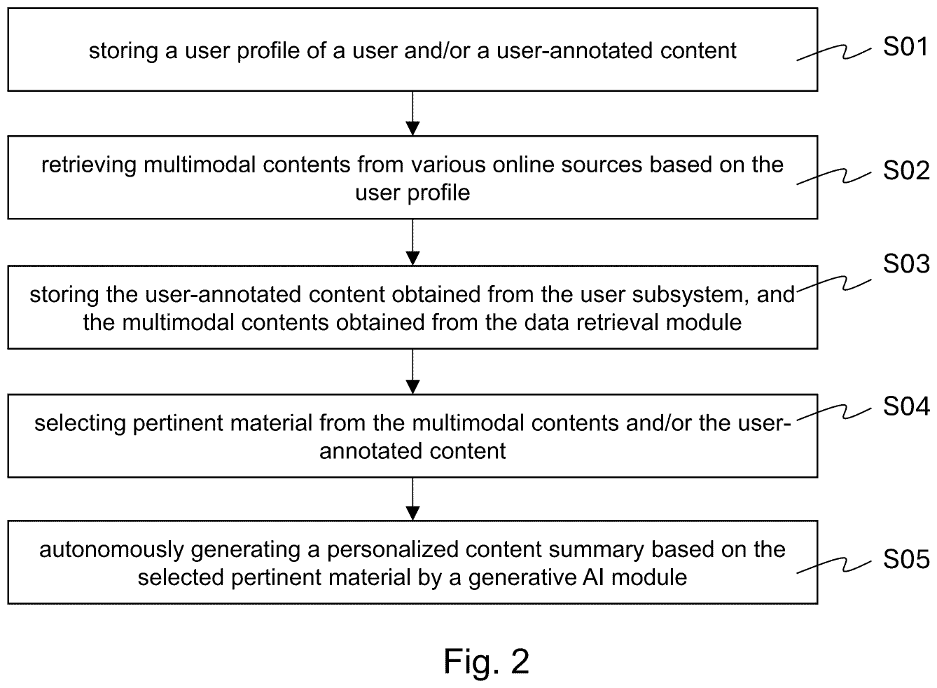

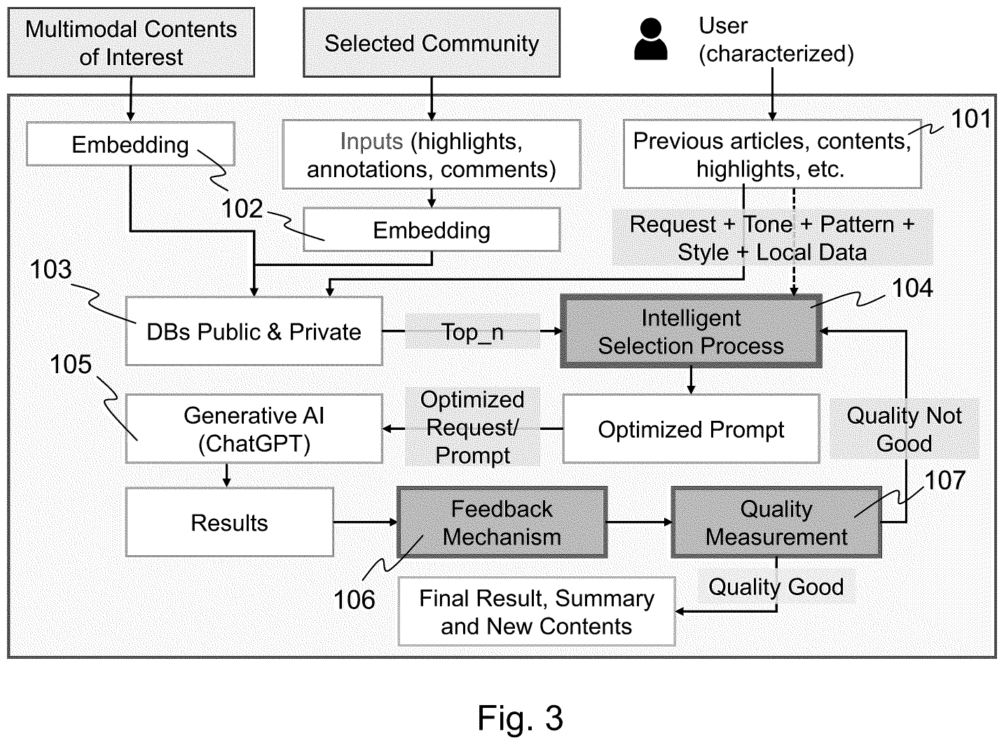

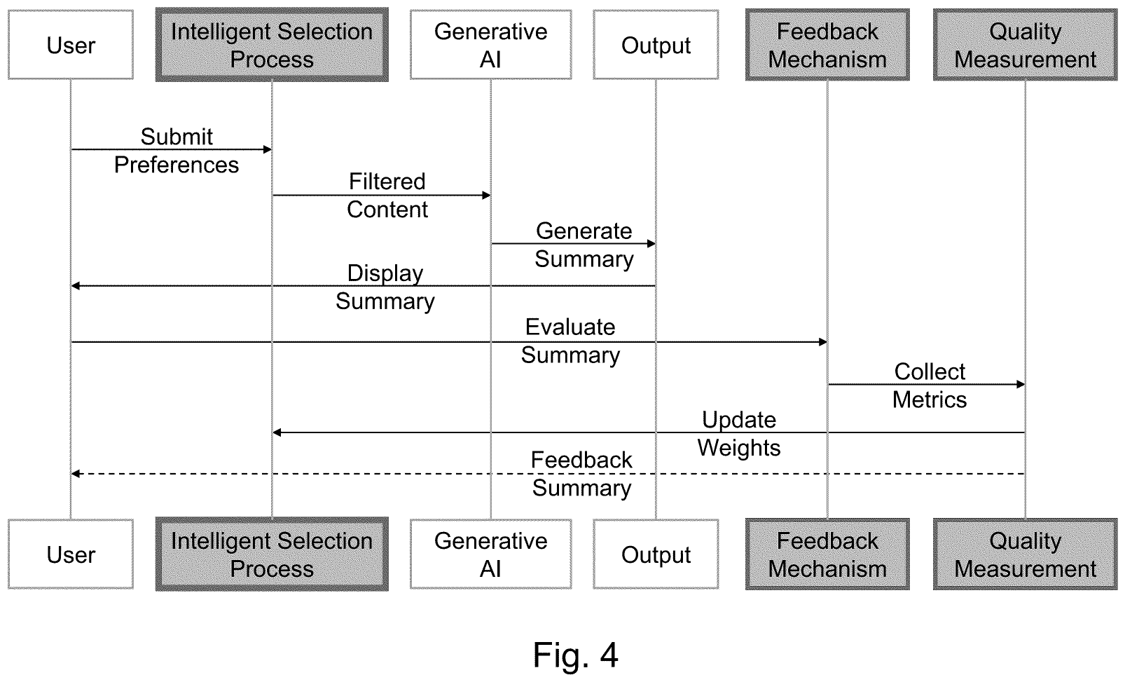

For a better understanding of the present invention, please refer to FIG. 2 which is a flowchart illustrating a method for generating a personalized summary of content according to an embodiment of the present invention, along with FIGS. 3 and 4 which provide conceptual overviews of the method. The method involves several steps: first, storing a user profile or user-annotated content to the user subsystem 101 (step S01); then, retrieving multimodal contents from various online sources 200 based on the user profile by the data retrieval module 102 (step S02). Subsequently, the user-annotated content and/or multimodal contents are stored in the content database 103 (step S03). The next step involves selecting pertinent material from the multimodal contents and/or user-annotated content by the selection module 104 (step S04). Finally, a generative AI module autonomously generates a personalized content summary based on the selected pertinent material (step S05).

In step S01, users are encouraged, though not obligatory, to supply an annotated version of the content intended for summarization. The system 100 offers users the choice to generate a personalized content summary either solely based on the user-annotated content or in conjunction with annotations from other individuals or communities accessible through online sources 200. This preference is integrated into the user profile, encompassing the user's choices for the formats, objectives, tone, and sentiment of the personalized content summary. Additionally, users can furnish a list of trusted online sources for the data retrieval module 102 to obtain the required multimodal contents for generating the personalized content summary. The data retrieval module 102 can also retrieve multimodal contents based on the social context and behavior of the content provider, or according to the user's desired interpretation for the generated personalized content summary.

Social context encompasses the broader social environment, incorporating cultural norms, values, and societal structures that impact how individuals and groups perceive and engage with information. Various social factors, including cultural perspectives, social values, biases and stereotypes, political and economic context, media influence, and public perception, can shape the interpretation and selection of data. Different cultures may prioritize and interpret data uniquely, while societal values play a pivotal role in shaping data perceptions. Biases and stereotypes can influence data collection and interpretation, potentially leading to the exclusion or exaggeration of specific data points. Additionally, the political and economic climate may impact how data is presented to align with certain ideologies or interests. Media outlets, influenced by societal expectations, can shape data presentation, and public perception, influenced by social context, contributes to data interpretation. It is crucial to be cognizant of these influences and critically evaluate data within its social context to understand potential biases or perspectives that may affect interpretation.

Hence, a notable aspect of the present invention is its ability to consider diverse factors, including social context, during the retrieval of data (i.e., multimodal contents) from online sources 200. This capability serves to include or prevent the perpetuation or reinforcement of societal biases in the generated personalized content summaries depending on the objectives of the user.

The user-annotated content or the annotations from other individuals or communities may be in various forms, including comments, highlights, notes, or other indicators added to emphasize specific parts of the content or provide additional context. Multimodal content refers to content that incorporates multiple modes of communication or expression. In the context of information or media, these modes typically include various forms such as text, images, audio, video, and interactive elements. The term emphasizes the use of different types of media to convey a message or provide a richer user experience. For example, a website with multimodal content might include written articles (text), images, and embedded videos to present information in a more comprehensive and engaging manner. In the field of artificial intelligence, multimodal models can process and understand information from different modalities, enabling a more holistic analysis of data. In essence, “multimodal content” suggests the integration of diverse media formats to convey information, cater to different styles and enhance the overall communication experience.

In step S02, the multimodal contents can be retrieved from various online sources such as webpages, websites, or other digital platforms hosted on different servers across the internet which encompasses a wide range of services, including but not limited to the World Wide Web. The data retrieval module 102 may utilize web crawling techniques, APIs, or other suitable means to gather relevant data from diverse online sources 200. Moreover, the retrieved multimodal contents, in addition to annotations, may encompass cited references related to the content intended for summarization.

In step S03, the content database 103 functions as the central storage repository for user-annotated content sourced from the user subsystem 101 and multimodal contents obtained from the data retrieval module 102. The content database 103 is versatile and can be deployed not only on a local computer for private use but also on a cloud-based server/platform for public access.

In step S04, the selection module 104 selects pertinent material aligning with the user's preferences and objectives predefined in the user profile from the multimodal contents and/or the user-annotated content. In this embodiment, the selection of the pertinent material from the multimodal contents relies on a trust score ranking assigned to each multimodal content. The trust scores are determined by assessing the reliability of the individual and/or community that contributed the multimodal content. Specifically, higher trust scores are assigned to content provided by individuals or communities with greater reliability or higher user satisfaction. This approach ensures that the selection of pertinent material is closely linked to the trustworthiness of the content sources. To enhance credibility, the trust score is dynamically adjusted based on user feedback, thereby maintaining a system that consistently delivers information from the most trustworthy sources.

For a more comprehensive grasp of the present invention, presented below is an illustrative formula utilized to calculate a trust score, providing a quantifiable measure of the trustworthiness of the multimodal content, ensuring the selection of the most relevant and high-quality contributions for the final output. It should be realized that this is merely an example and the present invention is not limited thereto.

Each individual input (highlight, annotation, comment) is scored based on the trustworthiness of the users who provided it. The scoring function S for an individual input i is given by:

$$S ( i ) = {\sum }_{j = 1}^{M} {w}_{j} \times {T}_{j}$$

where:
S(i) is the total score of input i.
M is the number of users who provided input i.
wⱼ is the weight associated with the trustworthiness of user j.
Tⱼ is the trust score of user j.

The “Top_n” function selects the n inputs with the highest trust scores to be processed in this step. The selected inputs are denoted as “Top_n”.

$$Top\_n = arg {max}_{n} ( S ( i ) )$$

In step S05, the selected “Top_n” inputs, along with the original content, are used as directives for the generative AI module to generate the personalized content summary. The generative process can be represented as:

$$G = f ( Top\_n , C , D )$$

where:
G is the generated content
f is the generative function.
“Top_n” are the selected inputs.
C is the original content.
D are the directives.

As previously mentioned, a feedback loop is established through the feedback module 106, enabling users to provide input on the generated content summaries. This feedback dynamically adjusts the trust scores, fine-tuning the generative AI module 105 for continuous improvement. To continuously improve the quality of the generated content, a quality validation score (Q) derived from both an anticipated value and an actual delivered value is employed. The quality validation score (Q) is calculated by the quality measurement module 107, and if the quality validation score (Q) falls below a predetermined threshold, the system 100 triggers a regeneration of the personalized content summary. Specifically speaking, the quality validation score (Q) will be feedback to the selection module 104 by the quality measurement module 107, and the personalized content summary would be regenerated by the generative AI module 105 through a reselection of pertinent material. The quality validation score (Q) is given by:

$$Q = \frac{1}{N} {\sum }_{í = 1}^{N} {( {w}_{4} \times {E}_{i} - {w}_{5} \times {D}_{i} )}^{2}$$

where:
Q is the quality validation score.
N is the number of metrics considered.
Eᵢ is the anticipated value for metric i as per the user.
Dᵢ is the actual delivered value for metric i from the generated content.
w₄ and w₅ are the respective weights for these metrics.

Here is an illustrative summary of the classic novel “Pride and Prejudice”, generated by a contemporary AI model without the implementation of the present invention.

“Pride and Prejudice,” penned by the iconic Jane Austen, is a timeless classic that delves into the intricacies of love, social hierarchy, and personal development. Set in the early 19th century, the novel revolves around Elizabeth Bennet, one of five daughters in a respectable but not wealthy family. Elizabeth is intelligent, witty, and independent, which sets her apart in a society that often reduces women to mere marital prospects. Opposite her is Mr. Darcy, a wealthy, reserved, and seemingly arrogant man. Their initial encounters are filled with misunderstandings and judgments, primarily fueled by Elizabeth's with and Mr. Darcy's pride. As the story unfolds, both characters undergo significant transformations. Elizabeth learns to look beyond her initial judgments, while Mr. Darcy learns humility and the value of genuine affection. The novel also serves as a keen observer of its time, critiquing the rigid class structures and social mores that dictated people's lives. It is a story that, while rooted in its era, remains universally relevant, inviting readers to explore deeper themes of human nature and societal constructs.

For comparison purposes, presented below is an illustrative summary generated by the system 100 of the present invention.

The novel “Pride and Prejudice” opens with a line that has been heralded as one of the best opening lines in literature: “It is a truth universally acknowledged, that a single man in possession of a good fortune, must be in want of a wife.” This line sets the stage for a narrative that is rich in character complexity and emotional depth. Elizabeth Bennet is not just a strong-willed young woman; she is a symbol of resistance against societal norms that seek to confine her. Mr. Darcy, on the other hand, is a study in contrasts. He is wealthy and privileged but also socially awkward, a trait that often masks his true feelings and intentions. One of the most emotionally stirring moments in the book is when Elizabeth reads Mr. Darcy's letter after rejecting his proposal. It serves as a turning point, not just for their relationship but also for their personal growth. The characters in the novel are not driven by love or hate in isolation; they are influenced by a complex web of social expectations, personal prejudices, and hidden vulnerabilities. Jane Austen employs wit, irony, and exquisite character development to not just tell a love story but to critique the social fabric of her time. The novel is a masterclass in how to use narrative and dialogue to expose the hypocrisies of society while also making the reader deeply invested in the personal journeys of the characters.

For a more in-depth understanding of the distinctions between the summary produced by a contemporary AI model and that generated by the present invention, a tabular comparison is provided below, encompassing various aspects:

| | Summary generated by | Summary generate by |
|---|---|---|
| Aspect | ChatGPT | the present invention |
| Opening | General introduction to the | The introduction includes the “best |
| | book and its themes. | opening line ever,” adding a personal |
| | | touch. |
| Character | Briefly describes Elizabeth | Delves deeper into the characters, |
| Analysis | Bennet and Mr. Darcy. | especially Mr. Darcy, using insights |
| | | from the present invention prompts. |
| Plot | Covers major plot points in a | Highlights specific moments in the |
| Highlights | straightforward manner. | plot that are emotionally impactful, |
| | | adding a layer of personal |
| | | interpretation. |
| Themes | Discusses themes of love, | Explores the same themes but with |
| | social class, and personal | added depth, incorporating |
| | growth. | motivations and societal norms. |
| Literary | Mentions that the book is a | Discusses Austen's wit and rhetorical |
| Devices | social commentary. | devices, adding a layer of literary |
| | | analysis. |
| Emotional | General emotional tones are | Emotional tones are deeply analyzed, |
| Resonance | described. | including the “alchemy” that makes |
| | | the novel enjoyable. |
| Reader | Invites the reader to explore | Validates the reader's potential |
| Engagement | more about the book's | feelings and questions about the book, |
| | themes, characters, or literary | thanks to insights from the present |
| | devices. | invention. |
| Depth | Provides a comprehensive | Goes beyond the overview to offer |
| | overview of the book. | nuanced insights and personal |
| | | interpretations. |
| Personalization | Standard book summary | Highly personalized, incorporating |
| | without personalized content. | specific insights from the present |
| | | invention, adding unique perspectives. |

The utilization of the present invention in content and summary creation brings forth a myriad of benefits, fundamentally transforming the landscape of analysis and engagement. Firstly, the invention facilitates a profound depth of analysis. In comparison to standard summaries, those generated with the present invention delve into the intricacies of character motivations, plot nuances, and thematic elements, providing readers with a more comprehensive and richer understanding of the content.

Furthermore, the present invention excels in personalization, allowing for the infusion of personalized insights and perspectives into the content. This integration enhances relatability and engagement for the reader, capturing subtleties that may be overlooked by conventional automated summaries. Moreover, the invention introduces emotional resonance, adding layers of emotional interpretation that elevate the overall impact of the content. This focus on emotional connection goes beyond mere information delivery, creating summaries that resonate deeply with readers and evoke a more profound response.

The innovation extends beyond mere summarization to include literary analysis, where it dissects specific lines, rhetorical devices, and narrative techniques contributing to a work's significance. This analytical depth offers readers a more nuanced understanding of the artistic elements at play. Notably, the automation aspect of the present invention emerges as a significant advantage, efficiently generating high-quality summaries, analyses, or other types of content. This automation not only saves valuable time and effort but also ensures consistent and reliable output.

Ultimately, the incorporation of the present invention in content creation enhances reader engagement. The added depth and personalization encourage readers to interact with the content, prompting questions and, in some cases, motivating them to explore the original work for a more comprehensive understanding. Thus, the present invention stands as a transformative force in content creation, offering a multifaceted approach that goes beyond conventional summarization to deliver enriched, personalized, and emotionally resonant content.

The versatility of the present invention extends across diverse sectors, offering a broad spectrum of applications. While the examples below highlight its immediate capabilities, it is essential to recognize that the platform's utility is not limited to these scenarios alone.

In the realm of education, the present invention proves invaluable for students and educators alike. It can effortlessly generate concise yet comprehensive summaries of academic papers, textbooks, and lectures, tailoring the content to individual learning styles and curriculum requirements. This customization fosters an enriched learning experience, providing students with targeted insights aligned with their educational objectives.

Busy professionals navigating the deluge of information in the digital age find solace in the present invention's proficiency in news aggregation. By quickly summarizing news articles, the platform offers professionals a swift yet thorough overview of current events relevant to their fields or personal interests, streamlining information consumption in a time-efficient manner.

For researchers and analysts, the present invention becomes a powerful tool for synthesizing information from multiple research papers. This functionality provides a cohesive and personalized summary of the current state of research on a particular topic, facilitating more efficient literature reviews and knowledge extraction.

Organizations keen on enhancing knowledge management systems can seamlessly integrate the present invention. This incorporation results in personalized content recommendations, summaries, and insights, thereby elevating decision-making processes and overall productivity within the organizational framework.

Academic institutions and research organizations can leverage the present invention to create personalized research systems. These platforms not only aggregate and summarize relevant literature but also offer personalized research pathways based on users' past behavior and future research goals, fostering a more tailored and efficient research experience.

In the digital realm, social media influencers and content creators find a valuable ally in the present invention. By harnessing collaborative input from their follower base, the platform aids in generating personalized, engaging posts, enhancing the overall content creation process.

Healthcare professionals benefit from the present invention's capabilities in information summarization. Medical professionals can quickly summarize patient histories, medical literature, and treatment options, leading to more informed decision-making and streamlined healthcare processes.

In the legal domain, law firms can employ the present invention to tackle the challenge of summarizing large volumes of legal documents, case histories, and precedents. This aids in quicker and more accurate case assessments, contributing to efficiency in legal workflows.

Businesses looking to enhance customer service can integrate the present invention into their platforms. By providing personalized and context-aware responses to customer queries, the platform improves customer satisfaction and reduces response time, contributing to a more efficient and customer-centric service model.

It is to be understood that the specific order or hierarchy of steps in the methods disclosed is an illustration of exemplary processes and may be rearranged based upon design preferences. The accompanying method claims present elements of the various steps in a sample order, and are not meant to be limited to the specific order or hierarchy presented unless specifically recited therein.

Although embodiments have been described herein with respect to particular configurations and sequences of operations, it should be understood that alternative embodiments may add, omit, or change elements, operations and the like. Accordingly, the embodiments disclosed herein are meant to be examples and not limitations.

What is claimed is:

1. A method for generating a personalized summary of content, comprising the steps of:
storing a user profile of a user and/or a user-annotated content;
retrieving multimodal contents from various online sources based on the user profile;
storing the user-annotated content obtained from the user subsystem, and the multimodal contents obtained from the data retrieval module;
selecting pertinent material from the multimodal contents and/or the user-annotated content; and
autonomously generating a personalized content summary based on the selected pertinent material by a generative artificial intelligence (AI) module.

2. The method according to claim 1, wherein the user profile comprises social context, preferences, objectives, formats, sentiment, behavior, and trusted online sources predetermined by the user, and the personalized content summary is adjusted accordingly.

3. The method according to claim 1, wherein each of the multimodal contents is assigned a trust score determined by a trustworthiness of an individual and/or community who supplied the multimodal contents.

4. The method according to claim 3, wherein the pertinent material is selected from the multimodal contents according to a ranking of the trust scores assigned to each multimodal content.

5. The method according to claim 3, wherein the trust score is dynamically adjusted based on a feedback of the user, and forwarded to the generative AI module for fine-tuning.

6. The method according to claim 1, wherein the user evaluates the quality and relevance of the personalized content summary by assigning a quality validation score, which is derived from both an anticipated value and an actual delivered value.

7. The method according to claim 6, wherein the personalized content summary is regenerated by the generative AI module through a reselection of pertinent material if the quality validation score falls below a predetermined threshold.

8. The method according to claim 1, wherein the multimodal contents and the personalized content summary comprises text, images, audio, video, and interactive elements.

9. The method according to claim 1, wherein at least one of the user-annotated content and the multimodal contents comprises comments, highlights, and notes.

10. The method according to claim 1, wherein the personalized content summary is generated by Natural Language Processing (NLP) and Machine Learning (ML) algorithms.

11. A system for generating a personalized summary of content, comprising:
a user subsystem, for storing a user profile of a user and/or a user-annotated content;
a data retrieval module, connected to the user subsystem, for retrieving multimodal contents from various online sources based on the user profile;
a content database, connected to the user subsystem and the data retrieval module, for storing the user-annotated content obtained from the user subsystem, and the multimodal contents obtained from the data retrieval module;
a selection module, connected to the content database, for selecting pertinent material from the multimodal contents and/or the user-annotated content; and
a generative artificial intelligence (AI) module, connected to the selection module, for autonomously generating a personalized content summary based on the selected pertinent material.

12. The system according to claim 11, wherein the user profile comprises social context, preferences, objectives, formats, sentiment, behavior, and trusted online sources predetermined by the user, and the personalized content summary is adjusted accordingly.

13. The system according to claim 11, wherein each of the multimodal contents is assigned a trust score determined by a trustworthiness of an individual and/or community who supplied the multimodal contents.

14. The system according to claim 13, wherein the pertinent material is selected from the multimodal contents according to a ranking of the trust scores assigned to each multimodal content.

15. The system according to claim 13, wherein the trust score is dynamically adjusted based on a feedback of the user, and forwarded to the generative AI module for fine-tuning.

16. The system according to claim 11, wherein the user evaluates the quality and relevance of the personalized content summary by assigning a quality validation score, which is derived from both an anticipated value and an actual delivered value.

17. The system according to claim 16, wherein the quality validation score is feedback to the selection module if the quality validation score falls below a predetermined threshold, and the personalized content summary is regenerated by the generative AI module through a reselection of pertinent material.

18. The system according to claim 11, wherein the multimodal contents and the personalized content summary comprises text, images, audio, video, and interactive elements.

19. The system according to claim 11, wherein at least one of the user-annotated content and the multimodal contents comprises comments, highlights, and notes.

20. The system according to claim 11, wherein the personalized content summary is generated by Natural Language Processing (NLP) and Machine Learning (ML) algorithms.
